(19) United States
(12) Patent Application Publication
(10) Pub. No.: US 2004/0015874 A1
(43) Pub. Date: Jan. 22, 2004

(54) Method and apparatus for finding resource allocation errors in virtual machine compilers

(76) Inventor: David Ungar, Mountain View, CA (US)

Correspondence Address: GUNNISON MCKAY & HODGSON, LLP, 1900 GARDEN ROAD, SUITE 220, MONTEREY, CA, 93940, US

(21) Appl. No.: 09/855,433

(22) Filed: May 14, 2001

(51) Int. Cl. G06F 9/44

(52) U.S. Cl. 717/127; 717/131; 717/108

(57) ABSTRACT

A method and apparatus for resource allocation tracking by virtual machine compilers are described. The method may be used to track the allocation of any limited computer resource needed by a program. One embodiment tracks the allocation of temporary registers by a virtual machine compiler. This tracking mode allows easy testing of the compiler for resource allocation errors. In the referenced embodiment, for each possible temporary register usage in a stream of execution, the invention provides a method for a virtual machine compiler to provide an allocation indicator to track the use of temporary registers.

When tracking mode is enabled, before allocating a resource (temporary register) for use in the current scope, the compiler checks the allocation indicator of the corresponding temporary register. If the desired register is already allocated (its corresponding bit of the allocation indicator is set,) the invention halts the operation and informs the user of a temporary register allocation error. If the temporary register is not allocated, the compiler sets the bit of the allocation indicator to reserve the register, and proceeds to allocate the register. When the code section using the temporary register has completed the compiler turns off the bit corresponding to the temporary register that has just been freed.

### BACKGROUND OF THE INVENTION

1. Field of the Invention

This invention relates to the field of computer systems, and more specifically, to finding resource allocation errors in virtual machine compilers.

2. Background

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

Sun, Sun Microsystems, the Sun logo, Java and all Java-based trademarks and logos are trademarks or registered trademarks of Sun Microsystems, Inc. in the United States and other countries.

Producing an executable computer program image is a multi-step process. Traditionally, a programmer writes a computer program using a highly abstract computer programming language such as Pascal or C++. The program is made up of instructions and data, referred to as “source code.” To convert source code to an executable form the program must first be translated into “object code.” Object code is an intermediate form between the high level computer language and a lower level form, sometimes called native machine instructions or “machine code.” A program is translated from source code to object code by a method commonly called compilation. Object code is traditionally independent of the computer on which the program will eventually be executed.

To compile a program, a programmer runs a program (a compiler) to turn source code into object code. To translate object code into machine code the programmer would next join the object code, compiler libraries, and other information using a program called a “linker.” The output of the linking process is an executable program containing native machine instructions that will execute on a particular computer under a particular operating system. A compiled program must therefore be “targeted” to a particular computer and operating system when the program is compiled and linked. The process of compiling and linking a program is often referred to as “building” the program.

The process of building a program for a particular target can reduce program errors. Both the compiler and linker may identify some programming errors before program execution is attempted. Errors detected during the compiling and/or linking process are called compile time errors. Errors detected during the execution of a program are called runtime errors.

Alternatively, some computer languages such as BASIC are not compiled and linked, but are instead interpreted. A traditional “interpreter” is a program similar to a compiler and linker combined. It reads source code statements and converts them to native machine instructions as the program loads for execution.

Both compiled and interpreted languages have advantages over the other. Moreover, both have disadvantages. An advantage of interpreted languages is that the source program can be loaded and run independent of the computer and operating system being used. Only the interpreter need be built for the target machine. An advantage of compiled programs is that some errors can be detected and corrected at compile time. Interpreted languages are disadvantageous because errors in a program cannot be identified until the program executes. Compiled languages are disadvantageous because they must be built for a target computer and the executable program is therefore not portable.

Java Compilers

Modern computer languages, such as Java™, use an intermediate scheme between compiling and interpreting that resolve the disadvantages of compiled and interpreted programs. Java programs are compiled for a virtual machine target, making them computer platform (target) independent. The output of the Java compiler is Java object code. Java object code is a binary program targeted for execution by another program, an interpreter called the Java Virtual Machine (JVM). In some implementations, the Java object code consists of “bytecodes,” which are “native instructions” for the JVM. The Java object code is stored in a file called a “.class” file.

The JVM is an interpreter targeted to a particular platform; it interprets bytecodes at runtime. The process of interpretation comprises translating bytecodes into one or more native machine instructions at the time the instructions are required. Therefore, Java programs have the advantage of the pre-execution error checking of a compiled language and the platform independence of an interpreted language. The interface between the Java program and the platform are hidden from the program by the JVM.

Another type of Java compiler, called a just-in-time (JIT) compiler, will convert and cache Java object code as native machine instructions when the Java object code is loaded into memory. In effect, the JIT compiles bytecodes for the native machine as it executes. The first time a section of a program is processed, the code is run at interpreted speed; subsequent passes through the same section of code (e.g., a loop) are executed at native binary speed. A JIT compiler knows the exact details of the execution environment (cache sizes, whether floating point is emulated, amount of main memory, the number and type of registers, etc.) so it can conceivably generate higher performance code than a C compiler, which targets a more general environment.

When a JIT compiler is present, the Java Virtual Machine reads the “.class” file for interpretation and then passes the file to the JIT. JIT takes the bytecodes and compiles them into native machine code instead of interpreting them. These compiled segments, sometimes called “snippets” can be kept by the JIT for reuse if that section of the program executes again. For example, a loop would be compiled once by the JIT into a snippet of native machine code, and then the snippet reused each time the loop executes. In contrast, an interpreter would reinterpret the code of the loop each time the loop executes. Thus, it can actually be faster under some conditions to compile bytecodes and run the resulting native machine instructions than to just interpret them. The JIT is inconspicuously integrated into the Java Virtual Machine, but it makes Java code runs faster. Installation of JIT is optional in some environments.

Java is a dynamic language, so the compiler will not “statically” compile “.class” files into native machine code until the files are actually needed during execution. Thus, JIT is “just-in-time,” since it compiles methods on a method-by-method basis—just before they are called. If the same method is called more than once, code precompiled by the JIT can execute much quicker because the JVM can simply re-execute the native machine code.

However, it is not always advantageous to pre-compile snippets using the JIT function. In some circumstances, using precompiled snippets does not execute any faster than code being interpreted. For example, if the program is structured in a way that causes the JVM to spending significant time interpreting bytecodes, then pre-compiling the bytecodes will improve performance. But the program may be structured in a way that rarely reuses sections of code. In that case, the JIT function may even slow down execution, because the JIT is using cycles compiling bytecodes that could have been interpreted more quickly than compiled.

Register Allocation

Both JIT and traditional (fast-style) compilers concatenate previously determined sequences of native machine instructions together to perform bytecode instructions. These predetermined code sequences need to utilize a limited number of native machine resources (for example, registers) to store intermediate values. The allocations of some of the native machine's registers are managed globally. These “global registers” are tracked throughout the life of the Java program by the JVM, and used for values that must be maintained across multiple segments of program code. Using traditional methods, tracking the allocation and use of global registers requires a significant amount time and code. This can slow the execution of a Java program and reduce the advantages of JIT compilation.

For values that are not needed on a “global” program scale, an alternative is to allocate “temporary” registers. The compiler may use temporary registers for local computations and for short-term storage of local values. Temporary registers are also limited resources in the native machine—but the compiler and JVM reserve temporary registers for exclusively local use.

Predetermined sequences of native machine instructions often use temporary registers to manipulate values while executing bytecode instructions. Allowing predetermined sequences of native machine instructions to use temporary registers speeds JIT compilation because it eliminates the overhead associated with global register allocation for values stored on a short-term basis.

However, the use of temporary registers among multiple predetermined code sequences in JIT and fast-style compilers can complicate correct execution of the program by the JVM. Temporary register allocations are assigned when a predetermined code sequence is compiled. However, because the predetermined code sequences are compiled as needed, without recompilation, properly tracking the allocation of temporary registers is challenging and therefore a likely source of compilation error. Tracking the allocation of temporary registers becomes difficult because each predetermined code sequence is independently compiled.

For example, errors in register allocation occur when one pre-determined code sequence allocates a temporary register with a value to be used within a few instructions. If the compiler generates a predetermined code sequence that calls another predetermined code sequence, and both sequences uses the same temporary register then the value in that register will be unintentionally overwritten (“clobbered”) when the program executes.

Whenever a temporary register is in-use and a method calls another method it is possible for the value of temporary register set up by the first method to be clobbered by the second method, if the second method was compiled in advance to use the same temporary register. When the second method returns control to the first method, the temporary register would no longer contain the value the first method expected it to contain.

Detecting this type of error in the compiler is difficult, as execution may continue for some time before the clobbered register causes a fatal failure. It is also possible that the value that clobbered the original value is within correct range of the original value, yet still an incorrect value. In that case, error detection and isolation can be almost impossible.

Prior Solutions

Identifying and tracking compiler operations to prevent temporary register allocation errors is often difficult. In the past, compiler programmers would check the object code generated by a compiler “by hand,” tracing out the use of registers from one routine call to the next looking for misallocated temporary registers that might indicate an error (“bug”) in the compiler. This method was time consuming and tedious, and therefore prone to errors. Alternatively, some virtual machine compilers reject the use of temporary registers, absorbing the cost of global allocation for all registers used by the program. Neither solution is satisfactory for the optimal execution and testing of virtual machine compilers.

The prior art therefore lacks a method for register allocation tracking by virtual machine compilers.

### SUMMARY OF THE INVENTION

A method and apparatus for resource allocation tracking by virtual machine compilers are described. An example, in one embodiment of the invention, uses the invention to track allocation of temporary registers by a Java compiler. However, there is nothing to limit the invention to a particular type of computer resource. The method can be used to track the allocation of any computer resource allocated by a virtual machine compiler. This invention is not limit to the type of register allocation problem described herein as an example of the invention.

The present invention is a method for enhancing the debugging mode of virtual machine compilers, such as the Java compiler, for locating resource allocation errors. The method describes an enhancement to a typical virtual machine compiler “debugging mode” (a tracking mode), which tracks the allocation of any limited computer resource needed by a program. One embodiment tracks the allocation of temporary registers by a virtual machine compiler. In the referenced embodiment, for each possible temporary register usage in a stream of execution, the invention provides a method for a virtual machine compiler for a virtual machine to provide an allocation indicator to track the use of temporary registers.

When the tracking mode is enabled, before allocating a resource (temporary register) for use in the current scope, the compiler generates code to check an allocation indicator of the corresponding temporary register. If the desired register is already allocated (its corresponding bit of the allocation indicator is set) then the code generated by the method of the present invention halts execution and informs the user of a temporary register allocation error. Code is also generated such that if the temporary register is not allocated, the bit of the allocation indicator to reserve the register will be set, and execution proceeds to allocate the register. Finally, code is generated to turn off the allocation indicator corresponding to the temporary register when the register is to be freed. This tracking mode of the present invention allows easy testing of the compiler for resource allocation errors.

### BRIEF DESCRIPTION OF THE DRAWINGS

FIG. 1 is a block diagram of a virtual machine's compile time and runtime environments.

FIG. 2 is a flow diagram of the code generation process, in tracking mode, of one embodiment of the method of the present invention.

FIG. 3 is a runtime flow diagram of the process of one embodiment of the method of the present invention.

FIG. 4 is a flow diagram of the code generation logic for clearing allocation of a temporary register when the register is no longer needed in the method of the invention.

FIG. 5 is a flow diagram of the code generation logic for verifying register allocation of a temporary register before changing its value in the method of the invention.

FIG. 6 is a block diagram of one embodiment of a computer system capable of providing a suitable execution environment for an embodiment of the invention.

### DETAILED DESCRIPTION OF THE INVENTION

The invention is a method and apparatus for register allocation tracking for virtual machine compilers. In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

Though discussed herein with respect to the Java programming language and the Java Virtual Machine, the invention may be implemented in any environment that supports object or data access through references, and that provides information about resource allocation in a computer system.

In virtual machines that implement compiling bytecode input, such as the Java Virtual Machine, the component providing the information about live object references is the compiler. The compiler is responsible for compiling method code, and is therefore knowledgeable about allocation of temporary registers in snippets of precompiled bytecode. However, the Java Virtual Machine specification cannot predict where resource limitations may be encountered and does not mandate precisely when they can be reported. The present invention is a method for enhancing the debugging mode of virtual machine compilers, such as the Java compiler, for locating resource allocation errors. An embodiment of a processing environment and virtual machine implementation are more fully described below.

The problem of reusing currently allocated resources, such as temporary registers, is so common that some prior art solutions solve it by rejecting the use of temporary registers altogether. These approaches require all register usage to pass through one or more classic register allocation processes. For example, traditional virtual machine compilers may forgo temporary register usage and require allocation of general registers, and their associated overhead, for all operations. Alternately, a given implementation of a virtual machine compiler may require precompiled bytecode to push and pop registers using a stack. Another alternative in the prior art is to pass additional information between routines to indicate the use of the temporary registers. This also involves significant overhead. These approaches are slower than the use of temporary registers because the overhead associated with register allocation is added for every value to be stored, even if the value will only be used for a few cycles of the native machine. In a code snippet, which may be executed in a loop, this overhead cost could be prohibitive.

The Lava Environment

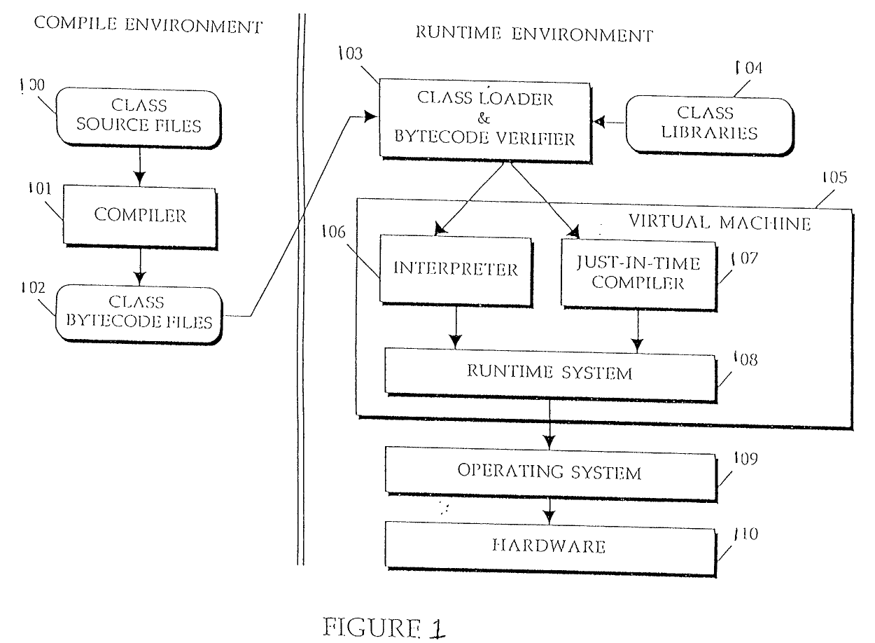

In one embodiment of the invention, the virtual machine is the Java Virtual Machine (JVM). Programmers create programs for the JVM using the Java processing environment. FIG. 1 illustrates the Java processing environment. The Java processing environment is object-oriented in nature. Java applications typically comprise one or more object classes and interfaces. Unlike many programming languages in which a program is compiled into machine-dependent, executable program code, classes written in the Java programming language are compiled into machine independent class files. Each class file contains code and data in a platform-independent format called bytecode. The computer system acting as the execution vehicle for the program runs another program, called a virtual machine, which is responsible for executing the code in each class file.

Applications may be designed as standalone Java applications, or as Java “applets” which are identified by an applet tag in an HTML (hypertext markup language) document, and loaded by a browser application. The class files associated with an application or applet may be stored on the local computing system or on a server accessible over a network. Each class is loaded into the Java virtual machine, as needed, by the “class loader.”

The classes of a Java applet are loaded on demand from the network (stored on a server), or from a local file system, when first referenced during the Java applet's execution. The virtual machine locates and loads each class file, parses the class file format, allocates memory for the class's various components, and links the class with other already loaded classes. This process makes the code in the class readily executable by the virtual machine.

Java Compilation

One embodiment of the invention is implemented for the Java processing environment. FIG. 1 illustrates the compile and runtime environments of the Java environment. In the compile environment, a software developer creates class source files 100, which contain the programmer readable class definitions written in the Java programming language, including data structures, method implementations and references to other classes. Class source files 100 are provided to Java compiler 101, which compiles class source files 100 into compiled “.class” files (class bytecode files 102) that contain bytecodes executable by a Java Virtual Machine. Class bytecode files 102 are stored (e.g., in temporary or permanent storage) on a server, and are available for download over a network. Alternatively, class bytecode files 102 may be stored locally on the client platform.

The Java runtime environment contains a Java Virtual Machine (JVM) 105 that is able to execute class bytecode files and execute native machine calls to operating system 109 when necessary during execution. Java Virtual Machine 105 provides a level of abstraction between the machine independence of the bytecode classes and the machine-dependent instruction set of the underlying computer hardware 110, as well as the platform-dependent calls of operating system 109.

Class loader and bytecode verifier (“class loader”) 103 is responsible for loading bytecode class files 102 and supporting class libraries 104 into Java Virtual Machine 105 as needed. Class loader 103 also verifies the bytecodes of each class file to maintain proper execution and enforcement of security rules. Within the context of virtual machine 105, either an interpreter 106 executes the bytecodes directly, or a “just-in-time” (JIT) compiler 107 transforms the bytecodes into reusable native machine code chunks (called snippets.) The bytecodes interpreted by runtime system 108 and the native machine code of snippets can be executed directly by hardware 110.

Runtime system 108 of virtual machine 105 supports general stack architecture. The manner in which such an architecture is supported by the underlying hardware 110 is determined by the particular virtual machine implementation, and reflected in the way the bytecodes are interpreted or JIT-compiled.

Compiler Resource Allocation Tracking

The following describes the unique steps of the method of the invention using temporary register allocation tracking as an example. While the present invention is illustrated in terms of temporary register allocation tracking, one of ordinary skill in the art will recognize that this method is equally applicable to the tracking of the allocation of any limited system resource by a virtual machine compiler. The method of the present invention includes both compile time and runtime aspects. The code generated at compile time by this method executes at runtime to produce the resource tracking required to debug compiler resource allocation errors.

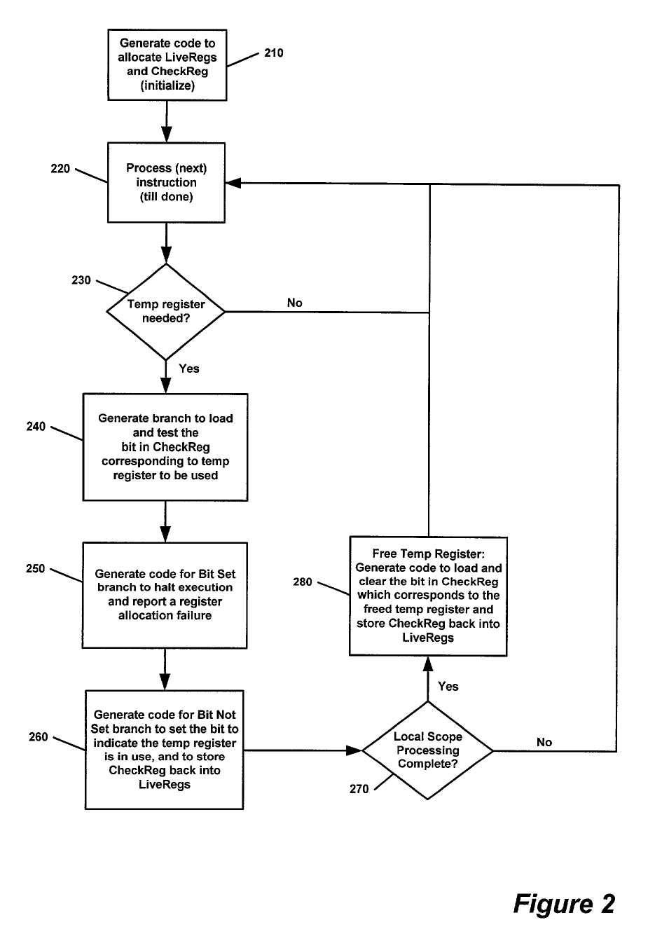

FIG. 2 describes the code generation process of the present invention. The figure illustrates the use of a register and a memory location to store information about the allocation of temporary registers or resources for the purposes of tracking a compiler's register allocation actions. Prior to the method, the compiler state is tested to see if tracking mode is enabled. The method of the present invention is a redundancy to a compiler debug mode, and may be enabled or disabled, using methods well known in the art such as compiler switches. If tracking mode is not enabled the method of the present invention is not executed. If tracking mode is enabled, code is generated at step 210 to allocate a memory location for allocation tracking (“LiveRegs”) for tracking register allocation. Additionally, one or more registers (bits contained in “CheckReg”) are either allocated or dedicated and serve as resource allocation indicators or register mapping indicators. Next, at step 220, each code generation step is evaluated to see if a temporary register is required. If not, processing returns to step 220. If a temporary register is required, then, at step 240 the compiler generates code to load LiveRegs into CheckReg and test the bit in CheckReg that corresponds to the temporary register to be allocated. For example in one embodiment of the invention, if the target system has eight temporary registers, and the code being compiled requires the allocation of temporary register 3, then bit 3 in CheckReg would be tested to see if bit 3 is set or unset. In the “Bit Set” branch, at step 250, code is generated to halt system execution and report an error. In the “Bit Not Set” branch, at step 260, code is generated to set the bit of CheckRegs corresponding to the temporary register required, then code is generated to store CheckReg back into LiveRegs, use the temporary register, and continue processing. When the temporary register is no longer needed (“Local Scope Processing Complete?” at step 270) the compiler generates code to load and clear the bit in CheckReg corresponding to the register being freed, and store CheckReg back into LiveRegs at step 280.

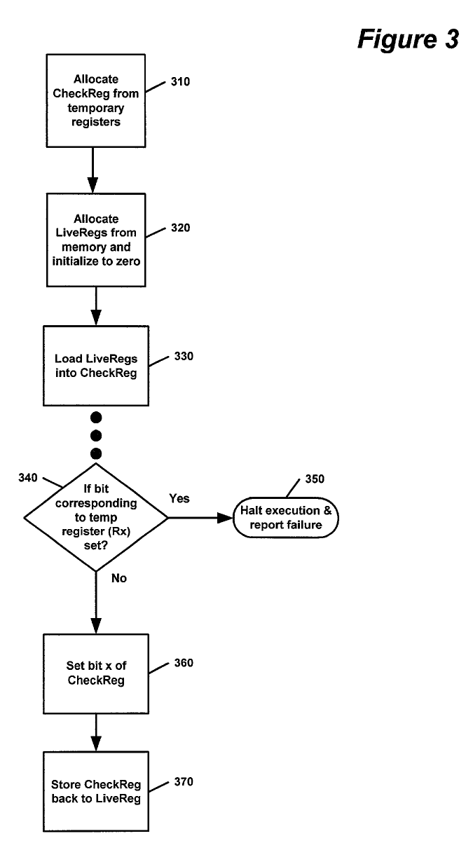

FIG. 3 details the runtime flow diagram of a tracking process in accordance with an embodiment of the invention. Using the code generated at compile time, the method begins by causing virtual machine 105 to allocate and initialize the register (CheckReg) and memory location (LiveReg) for tracking register allocation. At step 310, CheckReg is allocated from the temporary registers. In alternate embodiments of the invention, CheckReg may be allocated or dedicated. LiveRegs is allocated from memory and initialized to zero at step 320. Live Regs is loaded into CheckReg at step 340. Normal execution proceeds until the branch code (generated at step 240) is encountered. Next processing in this method resumes at step 340. If the bit of CheckReg corresponding to the temporary register to allocate is set, then at step 350, execution halts and a failure is reported using methods well known by those of skill in the art. If the bit is not set, then at step 360, the bit is set. At step 370 CheckReg is stored back into LiveRegs, and processing proceeds normally.

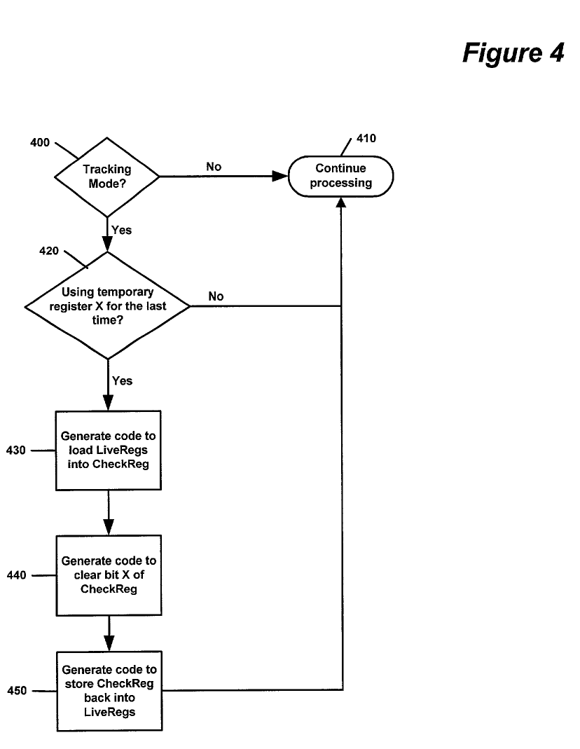

FIG. 4 shows the detail of steps to compile the last use of a temporary register in a given scope in the tracking mode of one embodiment of the present invention. At step 400, if tracking mode is enabled, at the end of a local scope of code generation the compiler test to see if a temporary register was allocated which will no longer be needed (step 420.) If not, processing proceeds at step 410. If a temporary register must be freed, code is generated to load LiveRegs into CheckReg at step 430. At step 440, code is generated to clear the corresponding bit of CheckReg. At step 450, CheckReg is stored back into LiveRegs. In either case processing proceeds normally from step 410.

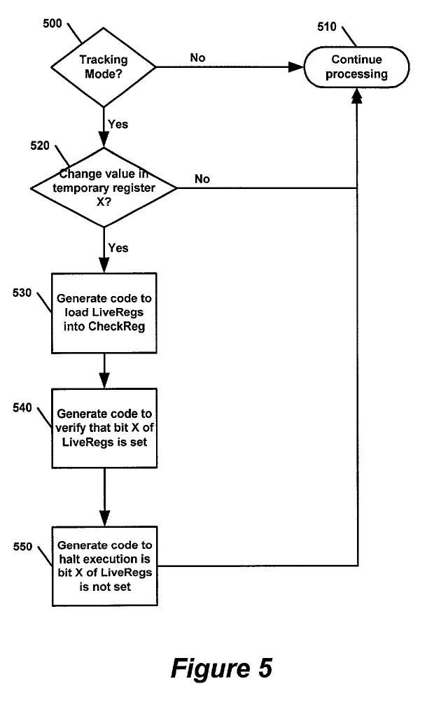

In a preferred embodiment of the invention, code will be generated to verify that the register contains a “live” value before changing the value. This embodiment is illustrated in FIG. 5. At step 500, as before, tracking mode is verified. If tracking mode is not enabled, processing continues at step 510. If tracking mode is enabled, step 520 tests for a need to generate code to change the value of a temporary register. If such a change is required, processing continues at step 530 and 540, where additional code is generated to verify that the temporary register contains a live value before generating the code to change the value. At step 530, code is generated to load LiveRegs into CheckReg. Next, at step 540, code is generated to verify that bit X of LiveRegs is set. Step 550 generates code to halt the execution if the corresponding bit of LiveRegs is not set.

Embodiment of Computer Execution Environment (Hardware)

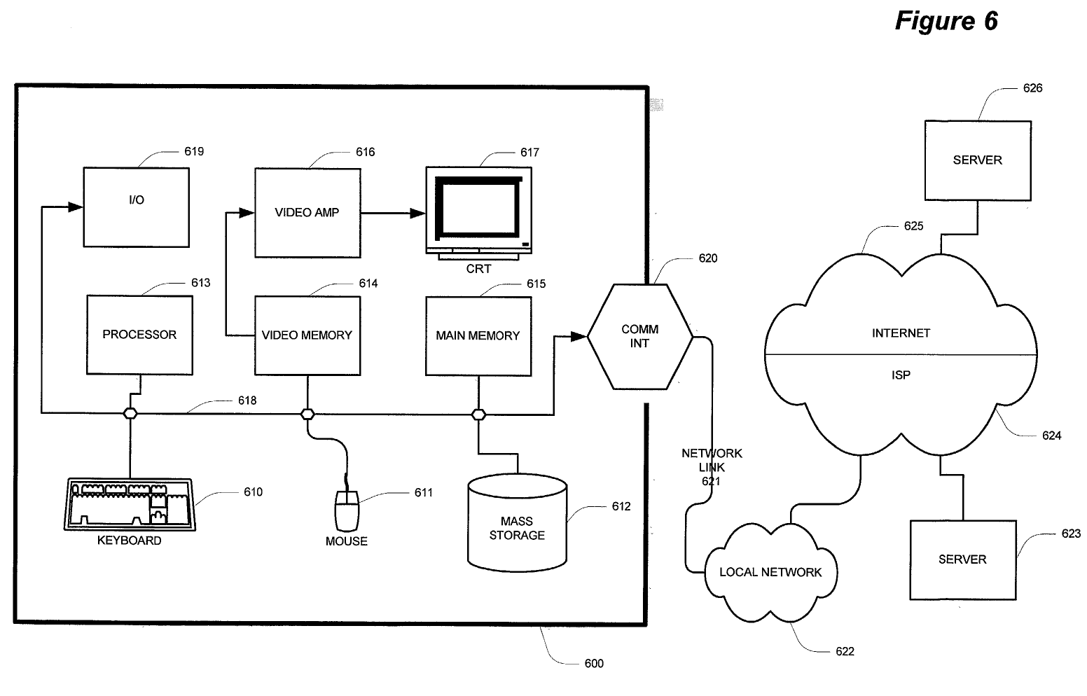

An embodiment of the invention can be implemented as computer A software in the form of computer readable code executed on a general-purpose computer such as computer 600 illustrated in FIG. 6, or in the form of bytecode class files executable within a Java runtime environment running on such a computer. A keyboard 610 and mouse 611 are coupled to a bidirectional system bus 618. The keyboard and mouse are for introducing user input to the computer system and communicating that user input to processor 613. Other suitable input devices may be used in addition to, or in place of, the mouse 611 and keyboard 610. I/O (input/output) unit 619 coupled to bidirectional system bus 618 represents such I/O elements as a printer, A/V (audio/video) I/O, etc.

Computer 600 includes a video memory 614, main memory 615 and mass storage 612 all coupled to bidirectional system bus 618 along with keyboard 610, mouse 611 and processor 613. The mass storage 612 may include both fixed and removable media such as magnetic, optical or magnetic optical storage systems or any other available mass storage technology. Bus 618 may contain, for example, address lines for addressing video memory 614 or main memory 615. The system bus 618 also includes, for example, a data bus for transferring data between and among the components, such as processor 613, main memory 615, video memory 614 and mass storage 612. Alternatively, multiplex data/address lines may be used instead of separate data and address lines.

In one embodiment of the invention, the processor 613 is a microprocessor manufactured by Motorola, such as the 680×0 processor or a microprocessor manufactured by Intel, such as the 80×86, or Pentium processor, or a SPARC microprocessor from Sun Microsystems, Inc. However, any other suitable microprocessor or microcomputer may be utilized. Main memory 615 is comprised of dynamic random access memory (DRAM). Video memory 614 is a dual-ported video random access memory. One port of the video memory 614 is coupled to video amplifier 616. The video amplifier 616 is used to drive the cathode ray tube (CRT) raster monitor 617. Video amplifier 616 is well known in the art and may be implemented by any suitable apparatus. This circuitry converts pixel data stored in video memory 614 to a raster signal suitable for use by monitor 617. Monitor 617 is a type of monitor suitable for displaying graphic images. Alternatively, the video memory could be used to drive a flat panel or liquid crystal display (LCD), or any other suitable data presentation device.

Computer 600 may also include a communication interface 620 coupled to bus 618. Communication interface 620 provides a two-way data communication coupling via a network link 621 to a local network 622. For example, if communication interface 620 is an integrated services digital network (ISDN) card or a modem, communication interface 620 provides a data communication connection to the corresponding type of telephone line, which comprises part of network link 621. If communication interface 620 is a local area network (LAN) card, communication interface 620 provides a data communication connection via network link 621 to a compatible LAN. Communication interface 620 could also be a cable modem or wireless interface. In any such implementation, communication interface 620 sends and receives electrical, electromagnetic or optical signals that carry digital data streams representing various types of information.

Network link 621 typically provides data communication through one or more networks to other data devices. For example, network link 621 may provide a connection through local network 622 to local server computer 623 or to data equipment operated by an Internet Service Provider (ISP) 624. ISP 624 in turn provides data communication services through the worldwide packet data communication network now commonly referred to as the “Internet” 625. Local network 622 and Internet 625 both use electrical, electromagnetic or optical signals that carry digital data streams. The signals through the various networks and the signals on network link 621 and through communication interface 620, which carry the digital data to and from computer 600, are exemplary forms of carrier waves transporting the information.

Computer 600 can send messages and receive data, including program code, through the network(s), network link 621, and communication interface 620. In the Internet example, remote server computer 626 might transmit a requested code for an application program through Internet 625, ISP 624, local network 622 and communication interface 620.

Processor 613 may execute the code received as it is received, and/or store the code in mass storage 612, or other non-volatile storage for later execution. In this manner, computer 600 may obtain application code in the form of a carrier wave. In accordance with an embodiment of the invention, an example of such a downloaded application is the apparatus for tracking a virtual machine described herein.

Application code may be embodied in any form of computer program product. A computer program product comprises a medium configured to store or transport computer readable code or data, or in which computer readable code or data may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment, including embedded devices (e.g., web phones, etc.) and “thin” client processing environments (e.g., network computers (NC's), etc.) that support a virtual machine.

Thus, a method and apparatus for finding resource allocation errors in virtual machine compilers are described.

1. A method in a computer system for identifying at runtime a resource allocation error generated by a virtual machine compiler encompassing generating code to perform steps at runtime, said steps comprising:
obtaining a resource allocation indicator at runtime;
testing at least one bit of said resource allocation indicator, wherein said at least one bit corresponds to an allocated resource;
halting execution if said at least one corresponding bit of said resource allocation indicator is set;
setting said at least one corresponding bit, when said at least one corresponding bit is unset, to indicate allocation of said corresponding resource; and,
unsetting said at least one corresponding bit when said corresponding resource is deallocated.

2. The method of claim 1 wherein the halting step performed at runtime further comprises generating an error condition when said at least one bit is set.

3. The method of claim 1 wherein the steps performed at runtime further comprise:
unsetting said at least one corresponding bit following a conditional branch wherein said corresponding resource is no longer required.

4. A method in a computer system of generating code to track at runtime the allocation of registers used in a virtual machine comprising:
generating code to allocate in memory a register mapping indicator;
generating code to determine if a register is available for allocation comprising:
generating code to test at least one bit of said register mapping indicator before loading the corresponding register with a value;
generating code to set said at least one bit of said register mapping indicator if said at least one bit is unset and allocation of said register is required;
generating code to fail if said at least one bit of said register mapping indicator is set and allocation of said register is required; and,
generating code to clear said at least one bit of said register mapping indicator when said register is no longer used.

5. A method in a computer system for tracking temporary register allocated by a virtual machine compiler comprising:
allocating a temporary register mapping indicator;
determining if a register is available for allocation by executing the steps comprising:
testing at least one bit of said temporary register mapping indicator before loading said register with a value;
setting said at least one bit of said temporary register mapping indicator if said at least one bit is unset;
failing if said at least one bit of said temporary register mapping indicators is set; and,
clearing said at least one bit of said temporary register mapping indicators when said register is no longer used.

6. A computer system for processing register allocation in a computer comprising:
a memory unit configured to store at least one allocation indicator;
a plurality of registers;
a compiler configured to generate code that will track at runtime the allocation of registers by executing the steps of:
designating an address in said memory unit to represent an allocation indicator;
loading said allocation indicator into one of said plurality of registers;
testing a bit of said allocation indicator to determine if said one of said plurality of registers is available for allocation;
setting said bit of said allocation indicator when it is unset to indicate that said one of said registers is unavailable for allocation;
failing when said bit is previously set; and,
clearing said at least one bit of said allocation indicator when said register is no longer used.
